(19) United States
(12) Patent Application Publication
(10) Pub. No.: US 2015/0291021 A1
(43) Pub. Date: Oct. 15, 2015

(54) FUEL SUPPLYING SYSTEM

(71) Applicant: HONDA MOTOR CO., LTD., Tokyo (JP)

(72) Inventors: Naoki Ogiwara, Wako-shi (JP); Masaki Wakao, Wako-shi (JP); Takeshi Watanabe, Wako-shi (JP); Kotaro Tanaka, Wako-shi (JP); Akihiro Taguchi, Wako-shi (JP)

(73) Assignee: HONDA MOTOR CO., LTD., Tokyo (JP)

(21) Appl. No.: 14/674,331

(22) Filed: Mar. 31, 2015

(30) Foreign Application Priority Data
Apr. 10, 2014 (JP) 2014-081386

(51) Int. Cl. B60K 15/04; B60K 15/03; B60K 15/073

(52) U.S. Cl. CPC B60K 15/04; B60K 15/073; B60K 15/03; B60K 2015/0474; B60K 2015/03269

(57) ABSTRACT

A fuel supplying system includes a socket component, a filler pipe, a connection, and a fuel tank. The socket component is positioned close to a fuel filler opening in a side of a vehicle body. The filler pipe is connected to the socket component at one end thereof and is connected to the connection at the other end thereof. The fuel tank houses a main part of the connection and stores fuel. The filler pipe extends through a space between a side portion of a wheelhouse and a rear wheel to the fuel tank, which is positioned at a bottom portion of the vehicle body. The fuel pipe is formed of a flexible material such that the fuel pipe is expanded by the fuel during refueling and is flat at times other than refueling.

### CROSS REFERENCES TO RELATED APPLICATIONS

The present application claims priority under 35 U.S.C. §119 to Japanese Patent Application No. 2014-081386, filed Apr. 10, 2014, entitled “Fuel Supplying System.” The contents of this application are incorporated herein by reference in their entirety.

### TECHNICAL FIELD

The present disclosure relates to an improved fuel supplying system for a vehicle.

### BACKGROUND

Vehicles include a fuel tank for storing fuel. The vehicle body includes a fuel filler opening through which the fuel is supplied to the fuel tank. A filler pipe extends between the fuel filler opening and the fuel tank. Japanese Unexamined Patent Application Publication No. 2003-182385, for example, discloses a technique relating to such a filler pipe.

As described in Japanese Unexamined Patent Application Publication No. 2003-182385, the filler pipe is a cylindrical pipe having a fuel passage. The filler pipe is bent at some parts so as not to come into contact with a wheelhouse or other components.

In common vehicles including such a filler pipe, the fuel filler opening is positioned in the side of the vehicle body at a position above a rear wheel, and the fuel tank is attached to the bottom portion of the vehicle. The rear wheel is covered by a wheelhouse, and the filler pipe is positioned inwardly from the wheelhouse in the vehicle width direction. The wheelhouse is positioned such that the rear wheel, which can be displaced while the vehicle is running on a rough surface, for example, does not come into contact with the rear wheel. In other words, there is sufficient clearance between the wheelhouse and the rear wheel since displacement of the rear wheel while the vehicle is running is taken into account.

A car compartment, where a passenger will be seated, is positioned further inward from the wheelhouse and the filler pipe in the vehicle width direction. A larger size of a car compartment is preferable for improved passenger comfort. However, it is difficult to reduce the clearance between the wheelhouse and the rear wheel to provide a larger car compartment.

### SUMMARY

One aspect of the present application describes a fuel supplying system that enables the car compartment to have a larger space, even at a position close to the wheelhouse.

According to a first aspect of this application, a fuel supplying system includes a filler pipe and a fuel tank. Fuel is supplied from a fuel filler opening in a side of a vehicle body to the fuel tank through the filler pipe. The filler pipe is disposed in and extends through a space between an exterior surface of a wheelhouse and a wheel to the fuel tank positioned at a bottom portion of the vehicle body. The filler pipe is formed of a flexible material such that the filler pipe is expanded by the fuel during refueling and is flat at times other than refueling.

The filler pipe of the fuel supplying system according to the first aspect extends through the space between the exterior surface of the wheelhouse and the wheel. Since the filler pipe is positioned outside the car compartment, the filler pipe does not occupy any space inside the car compartment, and thus the car compartment has a larger space. However, since the filler pipe is positioned between the wheelhouse and the wheel, the clearance between the wheel and the vehicle body is reduced. Thus, the filler pipe can come into contact with the wheel if the vehicle body is moved in the vertical direction while the vehicle is running.

However, the filler pipe according to the first aspect of this application is formed of a flexible material. The filler pipe is expanded by the fuel during refueling, but is flat at times other than refueling. Since the filler pipe is flat while the vehicle is running, the clearance between the wheel and the filler pipe is sufficiently large, and the filler pipe is kept away from the wheel. During refueling, the fuel flows through the filler pipe and expands the filler pipe, which reduces the clearance between the filler pipe and the wheel. However, the expanded filler pipe does not come into contact with the wheel, since the vehicle is at a stop and does not move in the vertical direction.

In the fuel supplying system according to the first aspect, the filler pipe is positioned outside the vehicle body. This creates an extra interior space in the vehicle. In addition, since the filler pipe is flat while the vehicle is running, the filler pipe does not come into contact with the rear wheel. This configuration prevents the filler pipe from coming into contact with the rear wheel and provides a larger interior space in the vehicle. In other words, the first aspect of this application provides the fuel supplying system that enables the car compartment to have a larger space, even at a position close to the wheelhouse.

According to a second aspect of this application, the fuel supplying system preferably further includes a socket component that is attached to the side of the vehicle body and configured to receive a fuel filler nozzle. The filler pipe may be connected to the socket component at an end portion thereof.

The fuel supplying system according to the second aspect includes the socket component that is attached to the side of the vehicle body and configured to receive the fuel filler nozzle. The filler pipe is connected to the socket component at the end portion thereof. The fuel filler nozzle is not inserted into the end portion of the filler pipe, but is inserted into the socket component connected to the end portion of the filler pipe. This facilitates insertion of the fuel filler nozzle into the socket component for refueling compared with direct insertion of the fuel filler nozzle into the fuel filler.

### BRIEF DESCRIPTION OF THE DRAWINGS

The advantages of the disclosure will become apparent in the following description taken in conjunction with the following drawings.

FIG. 1 is a perspective view of a vehicle including a fuel supplying system of an embodiment of the present application.

FIG. 2 is a perspective view of a filler pipe illustrated in FIG. 1.

FIG. 3 is a cross-sectional view of the vehicle illustrated in FIG. 1.

FIG. 4A to FIG. 4D are views each illustrating an operation of the fuel supplying system illustrated in FIG. 3.

FIG. 5 is a view illustrating how fuel is supplied to a fuel tank through the fuel supplying system illustrated in FIG. 3.

### DESCRIPTION OF THE PREFERRED EMBODIMENTS

An embodiment of the present application will be described with reference to the drawings. In the description, the term “right and left” indicates “the right and left side of a vehicle passenger”, and the term “front and rear” indicates “the front and rear of the vehicle in the vehicle driving direction”. In the drawings, the symbols “Fr”, “Rr”, “L”, “R”, “Up”, and “Dw” indicate the front side, the rear side, the left side of the passenger, the right side of the passenger, the upper side, and the lower side, respectively.

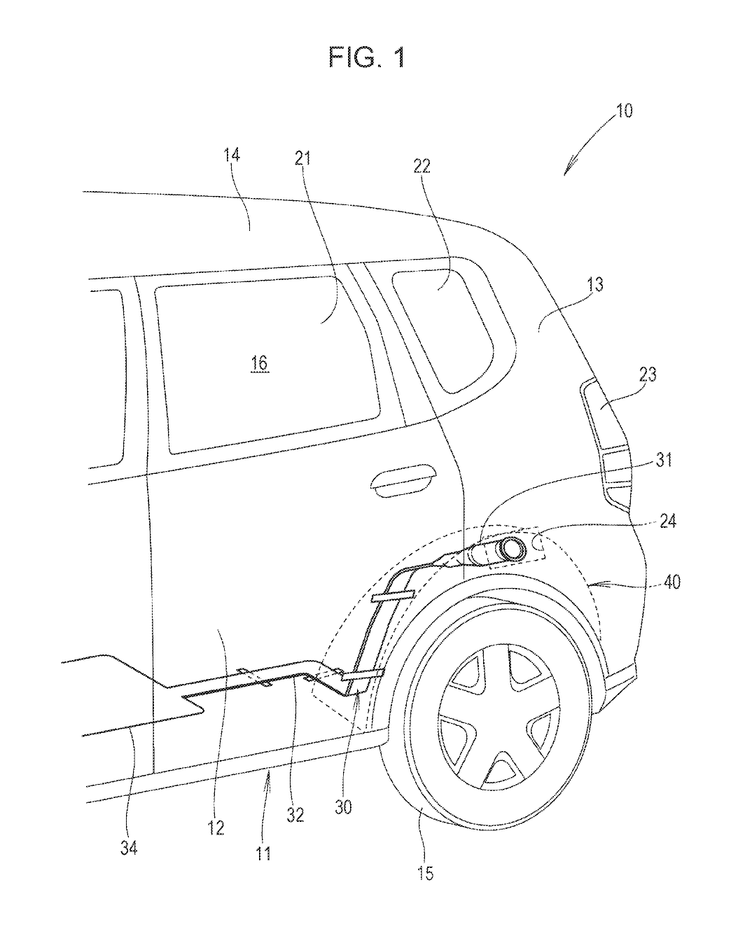

As illustrated in FIG. 1, a vehicle 10 includes a vehicle body 11 and a rear wheel 15. The vehicle body 11 includes a rear passenger door 12 on a lateral side thereof, a rear fender 13 at a rear part of the lateral side thereof, and a roof panel 14 as an upper part thereof. A compartment of the vehicle body 11 is a car compartment 16. The rear passenger door 12 includes a rear side glass pane 21. The rear fender 13 includes a rear quarter glass pane 22 and a tale lamp 23.

The rear fender 13 includes a fuel filler opening 24, through which the fuel is supplied, at a position above the rear wheel 15. A socket component 31, which is a component of a fuel supplying system and is configured to receive a fuel filler nozzle, is positioned close to the fuel filler opening 24.

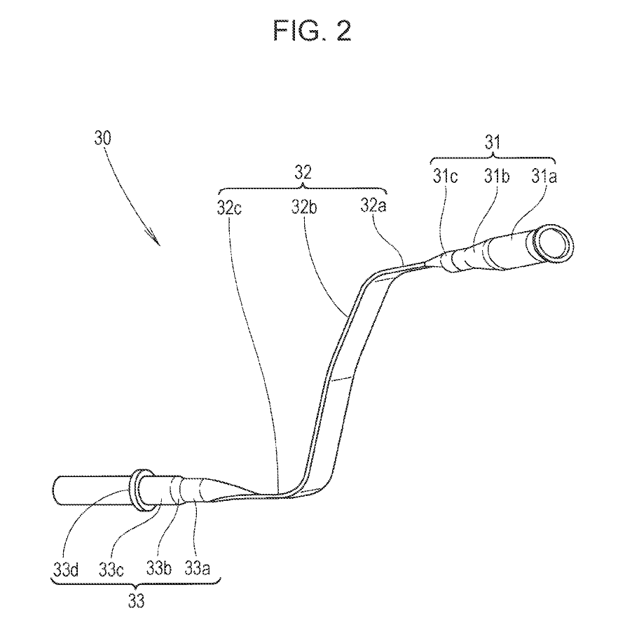

The fuel supplying system 30 will be described with reference to FIG. 1 and FIG. 2. The fuel supplying system 30 is mounted on a rear of the vehicle 10 to supply the fuel. The fuel is provided through the fuel filler opening 24 in the side of the vehicle body 11 to a fuel tank 34 through a filler pipe 32.

Specifically, the fuel supplying system 30 includes the socket component 31, the filler pipe 32, a connection 33, and the fuel tank 34. The filler pipe 32 includes a first end, which is connected to an end of the socket component 31 positioned close to the car compartment 16, and a second end, which is connected to the connection 33. The fuel tank 34 houses a main part of the connection 33 and stores the fuel. The fuel tank 34 is fixed to the bottom portion of the vehicle body 11.

The socket component 31 includes a first socket cylindrical portion 31a, a socket truncated cone 31b, and a second socket cylindrical portion 31c. The first socket cylindrical portion 31a is a filler inlet. The socket truncated cone 31b extends continuously from the first socket cylindrical portion 31a and gradually decreases in diameter with increasing distance from the first socket cylindrical portion 31a. The second socket cylindrical portion 31c extends continuously from the socket truncated cone 31b to the filler pipe 32.

The connection 33 includes a first connection cylindrical portion 33a, a connection truncated cone 33b, and a second connection cylindrical portion 33c. The first connection cylindrical portion 33a is connected to the filler pipe 32. The connection truncated cone 33b extends continuously from the first connection cylindrical portion 33a and increases in diameter with increasing distance from the first connection cylindrical portion 33a. The second connection cylindrical portion 33c extends continuously from the connection truncated cone 33b.

A flange 33d, which extends in the circumferential direction, is disposed on an outer periphery of the second connection cylindrical portion 33c to prevent entry of the connection 33 into the fuel tank (reference numeral 34 in FIG. 1).

The socket component 31 and the connection 33 are made of metal or resin and are not deformable. The filler pipe 32 is made of a flexible material and is deformable. The filler pipe 32 is a hose made mainly of polypropylene, for example. This provides the filler pipe 32 with resistance against fuel such as gasoline and allows the filler pipe 32 to change its shape. The filler pipe 32 is flat when not used for refueling. During refueling, the filler pipe 32 is expanded by the fuel pressure and is made to have a circular cross-sectional shape or an oval cross-sectional shape.

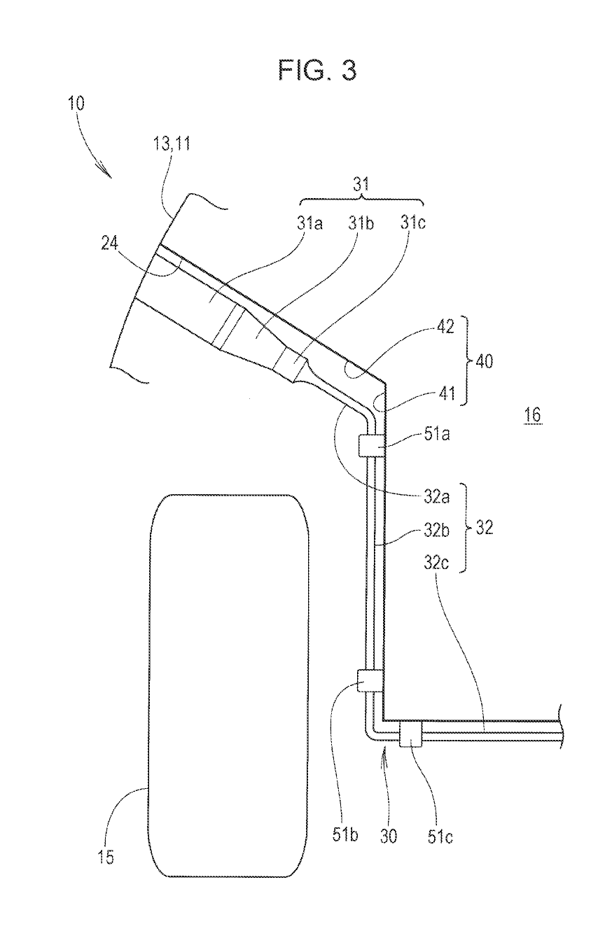

As illustrated in FIG. 3, a wheelhouse 40 includes a wheelhouse side portion 41 extending in a vertical direction along a side surface of the rear wheel 15 and a wheelhouse upper portion 42 extending from an upper edge of the wheelhouse side portion 41 to the rear fender 13. The wheelhouse upper portion 42 may extend obliquely. The wheelhouse side portion 41 may be a side wall of the wheelhouse 40.

The socket component 31 is positioned along the wheelhouse upper portion 42 in a space under the wheelhouse upper portion 42.

The filler pipe 32 includes a first filler pipe 32, a second filler pipe 32b, and a third filler pipe 32c. The first filler pipe 32a extends through a space between the wheelhouse upper portion 42 and the rear wheel 15 along the wheelhouse upper portion 42. The second filler pipe 32b extends through a space between an exterior surface of the wheelhouse side portion 41 and the rear wheel 15. The third filler pipe 32c extends through a space under the bottom portion of the vehicle body 11 to the fuel tank (reference numeral 34 in FIG. 1) along the bottom portion of the vehicle body 11.

The filler pipe 32 is fixed by elastically deformable first, second, and third straps 51a, 51b, 51c, respectively, each having an elongated shape. Specifically, the first strap 51a presses and fixes an upper end portion of the second filler pipe 32b onto an upper end portion of the wheelhouse side portion 41. The second strap 51b presses and fixes a lower end portion of the second filler pipe 32b onto a lower end portion of the wheelhouse side portion 41. Similarly, the third strap 51c fixes a lateral end portion of the third filler pipe 32.

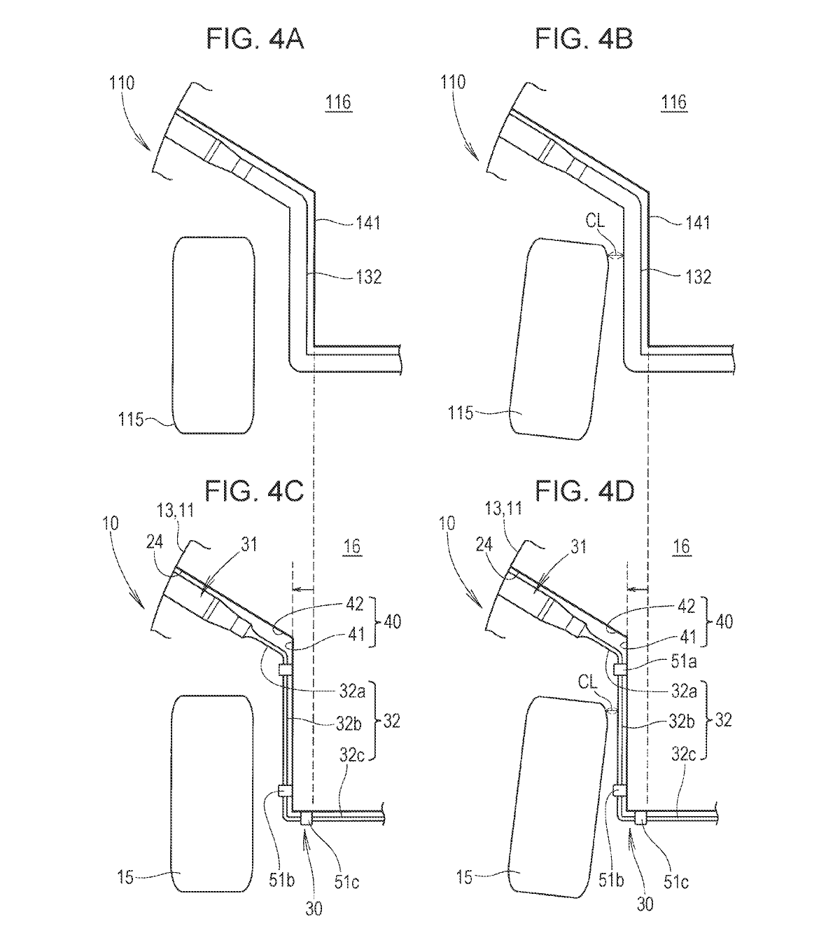

Next, an operation of this embodiment will be described with reference to FIGS. 4A to 4D. The filler pipe 32 is positioned outside the car compartment 16. A clearance CL between the rear wheel 15 and the filler pipe 32 and a space in the car compartment 16 of this embodiment will be compared with those in a comparative example including a filler pipe 132 having a predetermined shape that is positioned outside a car compartment 116.

As illustrated in FIG. 4A, the filler pipe 132 of the comparative example is positioned outside the car compartment 116. This may expand the space in the car compartment 116 because none of the space in the car compartment 116 is occupied by the filler pipe 132.

However, as illustrated in FIG. 4B, since the wheel 115 may be displaced while the vehicle 110 is running on a rough surface, the clearance CL needs to be provided between the wheel 116 and the filler pipe 132 so that the wheel 116 and the filler pipe 132 are not in contact with each other. However, the clearance CL may be reduced due to the thickness of the filler pipe 132 when the filler pipe 132 is positioned outside the car compartment 116. Thus, the wheel 116 and the filler pipe 132 may be in contact with each other. The wheelhouse side portion 141 needs to be positioned on or shifted to a further inward side of the car compartment 116 to have a sufficient clearance CL. This prevents the car compartment 116 from having a larger space.

As illustrated in FIG. 4C, the filler pipe 32, which is a component of the fuel supplying system 30 of this application, is formed of a flexible material and is flat when not used for refueling. Since the filler pipe 32 is flattened and thin, the clearance CL is not reduced when the filler pipe 32 is positioned outside the vehicle compartment 16. As illustrated in FIG. 4D, a sufficient clearance CL is achieved, without restricting the space in the car compartment 16. By this structure, the rear wheel 15 does not come into contact with the filler pipe 32. With this configuration, the space in the car compartment 16 may be expanded.

The pressure in the fuel tank (reference numeral 34 in FIG. 1) may be lower than the pressure in the filler pipe 32, and the fuel tank (reference numeral 34 in FIG. 1) may be configured to take the air thereto, i.e., the connection (reference numeral 33 in FIG. 22) of the filler pipe 32, for example, may be provided with a flap valve. In such a case, the fuel tank (reference numeral 34 in FIG. 1) is unlikely to take air thereinto because the filler pipe 32 is flat. This configuration is especially effective for reducing fuel evaporative emission in the fuel tank (reference numeral 34 in FIG. 1) that is formed of a flexible material the same as that of the filler pipe 32.

The third filler pipe 32c extends through the space under the bottom portion of the vehicle body 11 to the fuel tank (reference numeral 34 in FIG. 1) along the bottom portion of the vehicle body 11. The third filler pipe 32c is not positioned in the car compartment 16. The shape or position of the third filler pipe 32c does not need to be considered when components such as the vehicle body 11 are designed. This enhances the design possibility of the components.

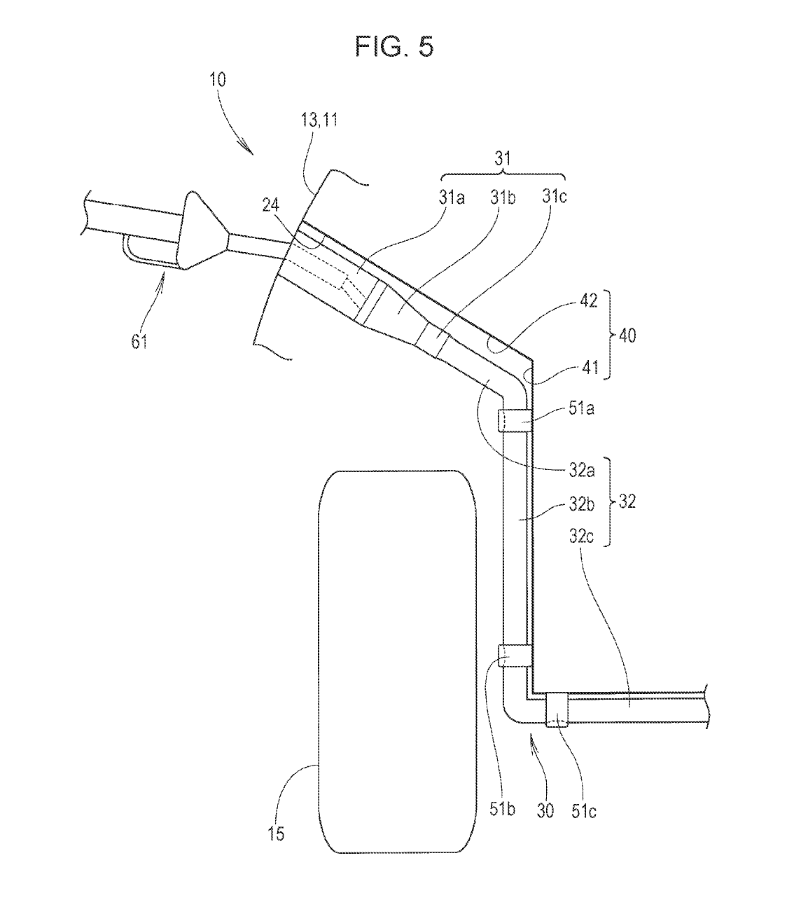

As illustrated in FIG. 5, fuel is supplied through the fuel filler opening 24 by a fuel filler nozzle 61. During refueling, the fuel flowing in the filler pipe 32 expands the filler pipe 32. The filler pipe 32 is expanded against elastic biasing force of the straps 51a, 51b, 51c.

The clearance between the filler pipe 32 and the rear wheel 15 is reduced as the filler pipe 32 expands. At this time, the vehicle 10 is at a stop and does not move in the vertical direction. Thus, the expanded filler pipe 32 does not come into contact with the rear wheel 15.

The filler pipe 32 returns to a flat shape (see FIG. 3) when the refueling ends and the fuel does not flow therein. The straps 51a, 51b, 51c also return to the original shape when the filler pipe 32 returns to the flat shape. The force required for the straps 51a, 51b, 51c to return to the original shape, i.e., biasing force of the straps 51a, 51b, 51c, helps the filler pipe 32 to return to its original flat shape. The operation stability of the filler pipe 32 is improved by the fixation of the filler pipe 32 to the vehicle body 11 (including the wheelhouse 40) by the straps 51a, 51b, 51c, which has high flexibility.

The filler pipe 32 of this application includes the socket component 31, which is configured to receive the fuel filler nozzle 61. The filler pipe 32 maintains its flat shape when the fuel does not flow therein. If the filler pipe 32 does not include the socket component 31, an end portion of the filler pipe 32 needs to be expanded every time the fuel filler nozzle 31 is inserted thereinto for refueling. The socket component 31 facilitates the insertion of the fuel filler nozzle 31.

The filler pipe 32 and the fuel tank 34 of this application are separate members, but may be an integral member.

The fuel supplying system according to this embodiment is preferably to be mounted in a passenger car. Although a specific form of embodiment has been described above and illustrated in the accompanying drawings in order to be more clearly understood, the above description is made by way of example and not as limiting the scope of the invention defined by the accompanying claims. The scope of the invention is to be determined by the accompanying claims. Various modifications apparent to one of ordinary skill in the art could be made without departing from the scope of the invention. The accompanying claims cover such modifications.

We claim:

1. A fuel supplying system comprising:
a filler pipe; and
a fuel tank, fuel being supplied to the fuel tank through the filler pipe from a fuel filler opening in a side of a vehicle body, wherein
the filler pipe is disposed in and extends through a space between an exterior surface of a wheelhouse and a wheel, to the fuel tank positioned at a bottom portion of the vehicle body, and
the filler pipe is formed of a flexible material such that the filler pipe is expanded by the fuel during refueling and is flat at times other than refueling.

2. The fuel supplying system according to claim 1, further comprising:
a socket component attached to the side of the vehicle body and configured to receive a fuel filler nozzle, wherein
the filler pipe is connected to the socket component at an end portion thereof.

3. The fuel supplying system according to claim 1, wherein the filler pipe is placed on and along the exterior surface of the wheelhouse.

4. The fuel supplying system according to claim 3, wherein the filler pipe has a flattened shape and is expandable by a pressure of the fuel running through the filler pipe.

5. The fuel supplying system according to claim 4, further comprising a biasing member applying a bias force to the filler pipe to keep the flattened shape.

6. The fuel supplying system according to claim 5, wherein the biasing member attaches the filler pipe to the exterior surface of the wheelhouse.

7. The fuel supplying system according to claim 5, wherein the biasing member is an elastic member elastically biasing the filler pipe.

8. The fuel supplying system according to claim 7, wherein the biasing member is an elastically deformable strap.

9. The fuel supplying system according to claim 7, wherein the biasing member is placed on a part of the exterior surface of the wheelhouse, the part facing to the wheel.

10. The fuel supplying system according to claim 2, wherein the socket component has a cylindrical shape, and wherein the filler pipe has a flattened shape and is expandable by a pressure of the fuel running through the filler pipe.

11. A vehicle comprising the fuel supplying system according to claim 1.
